(19) United States
(12) Patent Application Publication
(10) Pub. No.: US 2017/0140861 A1
(43) Pub. Date: May 18, 2017

(54) CONSTANT FORCE, SHORT-STROKE ELECTROMAGNETIC ACTUATOR

(71) Applicant: Hamilton Sundstrand Corporation, Windsor Locks, CT (US)

(72) Inventor: Jacek F. Gieras, Glastonbury, CT (US)

(21) Appl. No.: 14/944,992

(22) Filed: Nov. 18, 2015

(51) Int. Cl. H01F 7/08; H01F 41/02

(52) U.S. Cl. CPC H01F 7/081; H01F 41/0206; H01F 2007/086

(57) ABSTRACT

An electromagnetic actuator includes first winding and second windings passing through a first core and a second core, respectively. The first and second cores are arranged such that the first and second core slots form a gap their respective cores between the first and second windings and the first and second permanent magnets and the first and second core slots have a slot opening width (a), the first and second magnets have a magnet height (h) measured along the central axis that the first and second cores have a core height (H) measured along the central axis and h>a; H>h; and H−h<0.5 H.

### BACKGROUND OF THE INVENTION

The subject matter disclosed herein relates to actuators and, in particular, to a constant force, short-stroke electromagnetic actuator.

A linear actuator is an actuator that creates motion in a straight line, in contrast to the circular motion of a conventional electric motor. Linear actuators are used in machine tools and industrial machinery valves and dampers, and in many other places where linear motion is required. A short-stroke electromagnetic actuator is an electromechanical energy conversion device, which converts the electrical energy into mechanical energy of short-distance linear motion.

There are several manners in which an actuator can be formed. One is to convert a rotary motion in to a linear motion. Another is to apply a current to a winding surrounding a permanent magnet. Application of a current causes the magnet to move and this motion, in turn, causes a plunger attached to the magnet to move to deliver linear motion. However, in such cases, the amount of force provide may be dependent on the location of the magnet relative to the winding and the force is not constant. An electromagnetic actuator that delivers a constant force, regardless of plunger position would be well received by industry.

### BRIEF DESCRIPTION OF THE INVENTION

According to one aspect of the invention an electromagnetic actuator is disclosed. The electromagnetic actuator includes an outer housing having a central axis and a plunger contained at least partially within the outer housing and configured to move along the central axis, the plunger including an outer layer and first and second permanent magnets disposed within the outer layer and arranged such they are magnetized in opposite directions and perpendicular to the central axis. The electromagnetic actuator also includes a first core on a first side of the central axis and outside of outer layer, the first core having a first core slot and a second core outside of outer layer on a second side, opposite the first side, of the central axis, second core having a second core slot, and a first winding and second winding, the first winding passing through the first core and the second winding passing through the second core. In this embodiment, the first and second cores are arranged such that the first and second core slots form a gap their respective cores between the first and second windings and the first and second permanent magnets and the first and second core slots have a slot opening width (a), the first and second magnets have a magnet height (h) measured along the central axis that the first and second cores have a core height (H) measured along the central axis. In this embodiment, h>a; H>h; and H−h<0.5 H.

Also disclosed is a method of forming an electromagnetic actuator that includes: forming a plunger having a central axis, the plunger including an outer layer and first and second permanent magnets disposed within the outer layer and arranged such they are magnetized in opposite directions and perpendicular to the central axis; disposing a first core assembly on a first side of the central axis and outside of outer layer, the first core assembly including a first core having a first core slot and a first winding passing through the first core; and disposing a second core assembly on a second, opposite side of the central axis and outside of outer layer, the second core assembly including a second core having a second core slot and a second winding passing through the second core. In this embodiment, wherein the first and second cores are disposed such that the first and second core slots form a gap their respective cores between the first and second windings and the first and second permanent magnets and the first and second core slots have a slot opening width (a), the first and second magnets have a magnet height (h) measured along the central axis that the first and second cores have a core height (H) measured along the central axis and h>a; H>h; and H−h<0.5 H.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an actuator according to one embodiment;

FIG. 2 shows a side view of an actuator according to one embodiment;

FIG. 3 is cross-section of FIG. 2 taken along 3-3;

FIG. 4 is cross-section of FIG. 2 taken along 4-4;

FIG. 5 shows an embodiment of a core that may be used in an actuator according to one embodiment;

FIG. 6 shows a simplified version of the actuator shown in FIG. 3 illustrating the flux lines when no current is supplied to it;

FIGS. 7A-7B shows the actuator is illustrated in FIG. 6 and the resulting flux lines when current is applied (FIG. 7A) and after the plunger has moved a distance x (FIG. 7B) and;

FIG. 8 shows a graph of the force-position characteristic at constant current.

The detailed description explains embodiments of the invention, together with advantages and features, by way of example with reference to the drawings.

### DETAILED DESCRIPTION OF THE INVENTION

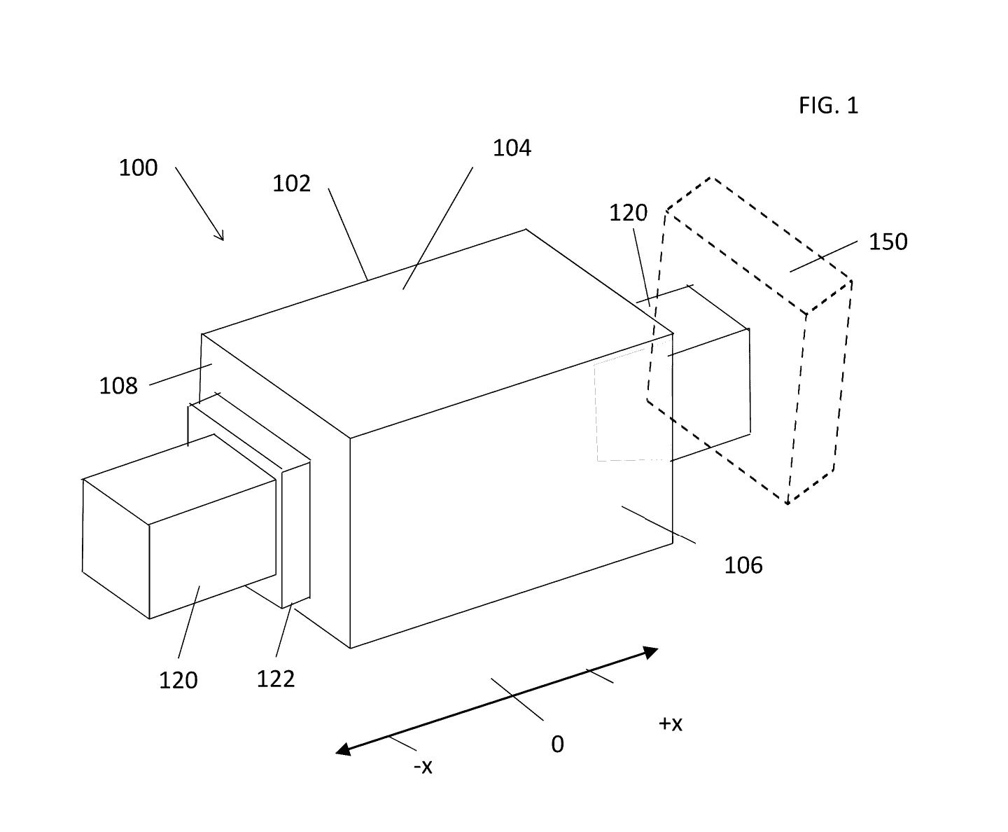

Shown in FIG. 1 is a perspective view of an electro-magnetic actuator 100 according to one embodiment. The actuator 100 includes an outer-housing 102. The outer housing 102 includes top 104, first side and a first end 108. The actuator includes a plunger 120 that extends outwardly from housing 102. As illustrated, the plunger 120 extends outwardly from an optional housing extension 122. While not visible in FIG. 1, the extension may include a linear bearing. In general, application of a current/voltage to the actuator 100 causes the plunger 120 to move in either the −x or +x direction depending on the polarity of the applied current. The x direction is measured from the middle of location of the middle of the plunger 120 when no current is applied. When conditions shown below are implemented, the force produced at an end of the plunger 120 is, in general, constant, i.e., practically independent of the position + or −x of the plunger 120. Such an actuator 100 may be used to control a fuel valve in one embodiment. A fuel valve is shown by dashed box 150.

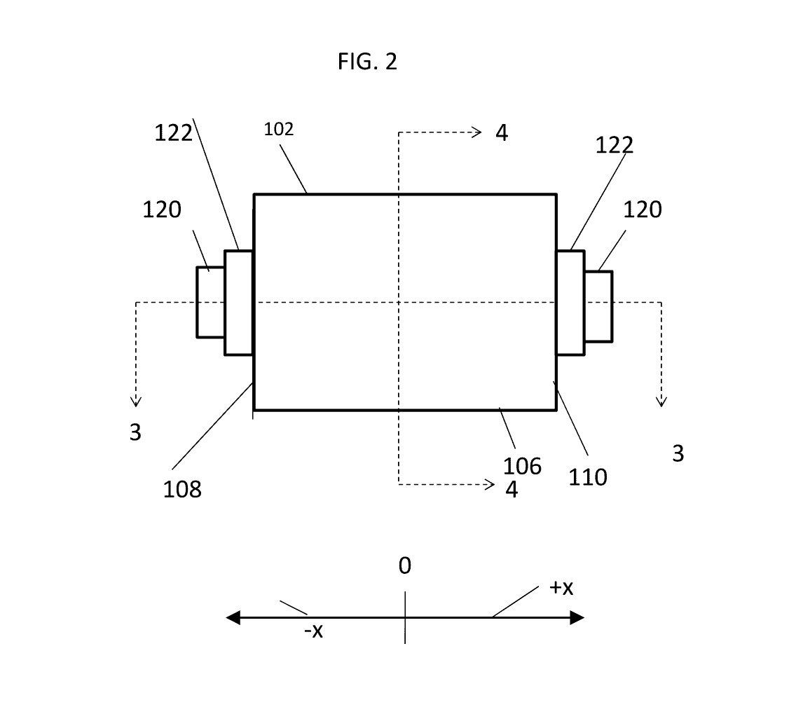

Shown in FIG. 2 is a side view of the electro-magnetic actuator 100. The actuator 100 includes an outer-housing 102. The outer housing 102 includes top 104, first side 106, first end 108 and a second end 110. The actuator includes a plunger 120 that extends outwardly from housing 102. As illustrated, the plunger 120 extends outwardly from an optional housing extension 122 that may include a linear bearing. In general, application of a current/voltage to the actuator 100 causes the plunger 120 to move in either the −x or +x direction depending on the polarity of the applied current.

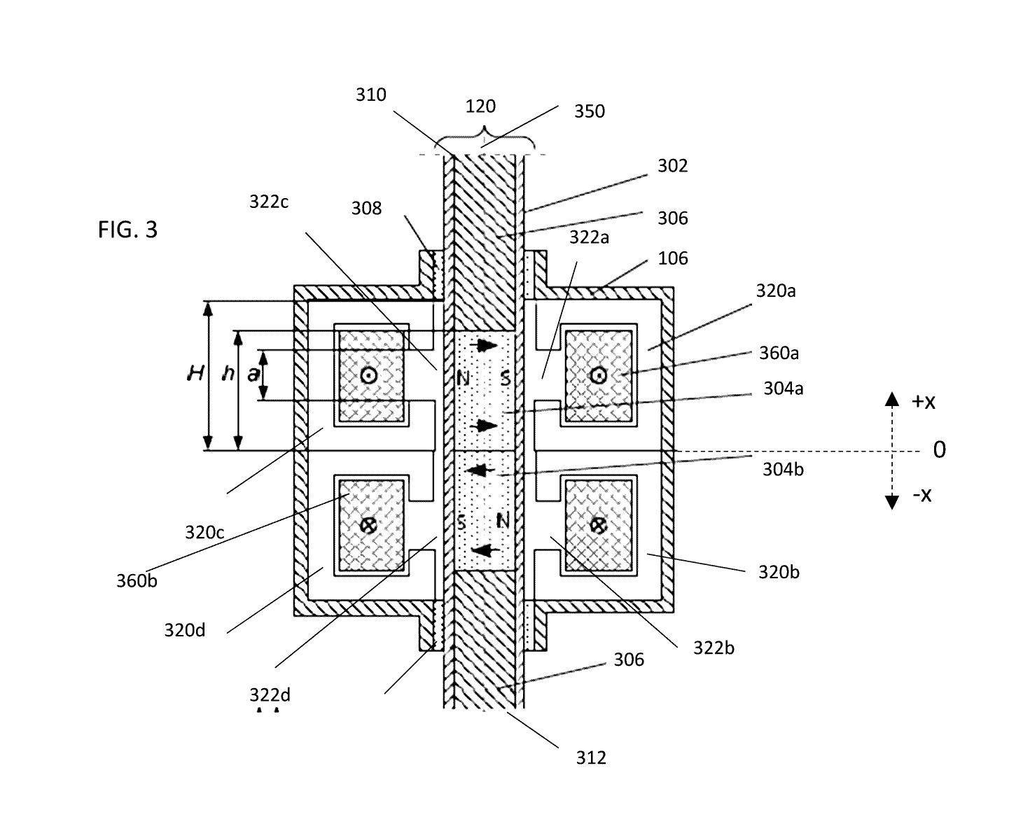

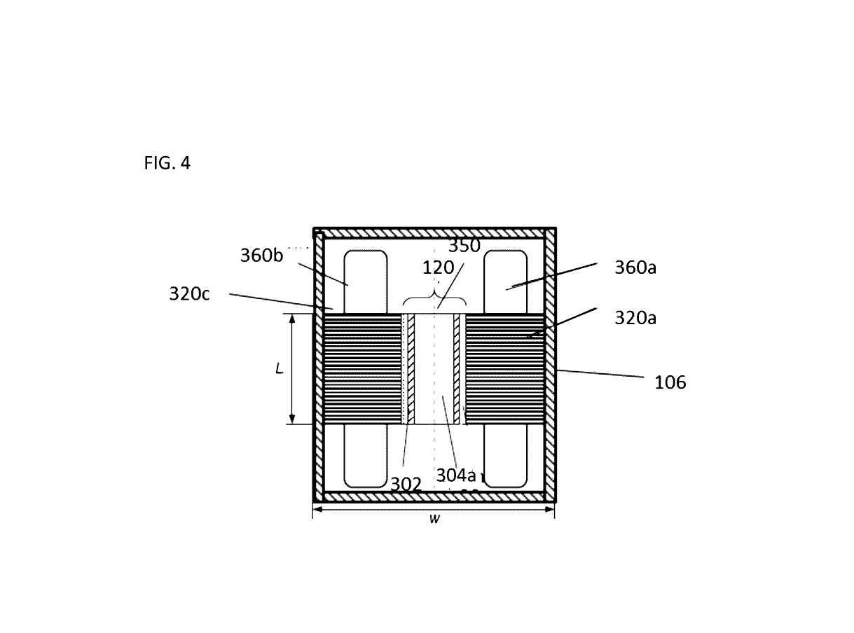

FIG. 3 shows a cross-section taken along section line 3-3 in FIG. 2 of an embodiment an electro-magnetic actuator 100 and FIG. 4 shows a cross-section taken along section line 4-4 in FIG. 2. The following discussion refers to both figures.

In this embodiment, the plunger 120 includes an outer layer 302 that is formed of a non-ferromagnetic material. Examples include aluminum, brass, bronze, stainless steel, plastics, etc.

Disposed with the outer layer 302 are first and second permanent magnets (PMs) 304a, 304b. Each of the magnets 304 are generally flat and have generally rectangular sides and tops and bottoms. From FIG. 3 the rectangular nature of the top and bottoms is clear and the end rectangular shapes are shown in FIG. 4. The PM's 304a, 304b are magnetized in opposite directions and the direction from N-S is perpendicular to the direction of motion x.

The space between ends 310, 312 of the plunger 120 and the PM's 304a, 304b is filled with by a non-ferromagnetic materials such as aluminum, brass, bronze, stainless steel, plastics, etc.

A linear bearing 308 is located within the outer housing 120. In one embodiment and as illustrated in FIG. 3, the linear bearing 308 is located within the housing extension 122. As illustrated, the actuator 100 includes 4 separate ferromagnetic cores 320a, 302b, 320c, 320d. Each core includes a slot 322a, 322b, 322c, 322d. One or more of the cores 322 may be laminated, made of sintered powder or even made of solid steel, because the actuator is fed with DC current during operation.

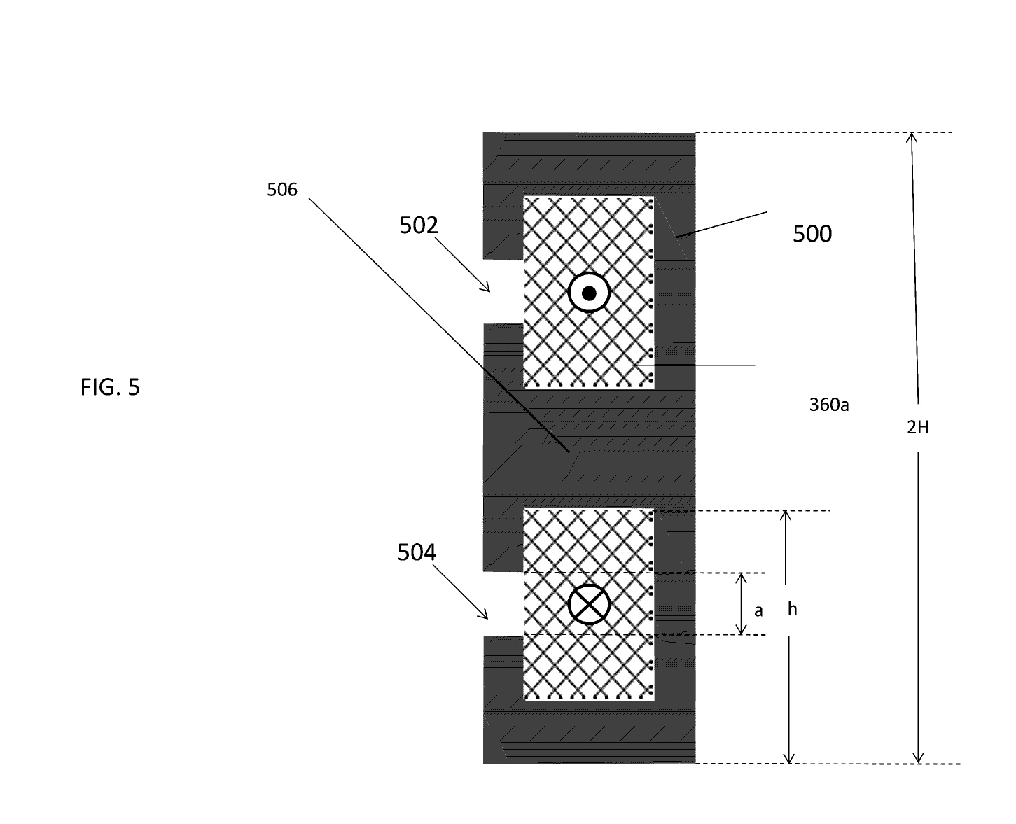

It shall be understood that the cores on each side of plunger 120 (e.g. 320a, 320b and 320c, 320) may be replaced with a single core having slots. For example, cores 320a and 320b may be combined to form a single core 500 with slots 502 and 504 as shown in FIG. 5. The same is also true of cores 320c and 320d. In FIG. 5, the core 500 includes a central arm 506 around with winding 360 is wrapped. That is, the winding 360 surrounds the central arm 506.

Regardless of the configuration of the core(s), the cores on a particular side (where “side” refers to being disposed on either the left or right side of center line or central axis 350) of the plunger 120 include a winding 360 wrapped around adjoining sides of the cores on that side. The windings 360 can be made of round or rectangular wire or can be wound using a copper or aluminum foil.

As shown in FIG. 3, winding 360a is on the right side of center line 350 and wraps around adjacent sides of cores 320a and 320b and winding 360b is on the left side of the center line 350 and wraps around adjacent sides of windings 320a and 320b and winding 360b. In one embodiment, neither winding 320a, 320b surrounds the plunger 120. That is, either winding 320a, 320b completely encircles an of the permanent magnets 304a, 304b.

The slots 322 all define an opening that exposes the windings to an adjacent magnet. Stated differently, the slots all define an opening in the core between the windings and the magnets as well as the center line. The outer housing 106 may a width, w, and the cores may a have a length, L, as shown in FIG. 4.

Application of a direct current to both windings 360a, 360 be will cause the plunger 120 to move in a first direction (e.g., +x) and application of current of an opposite polarity will have the opposite effect.

By following the requirements related to the sizing of slots 322, the magnets and the cores 320, embodiments may provide a constant force regardless of displacement in the x direction. In one embodiment the slot opening width, a, defines a width of the slots 322 and a magnet height, h, is the height of the magnet taken from 0 in the +x direction and H is the height of the core 320. With these conventions, the constant force may be created when:

h>a;

H>h; and

H−h<0.5 H

are all met.

It shall be understood that in the embodiment of FIG. 5, the actual core height is shown as 2H but is core height of H used, the above requirement still hold.

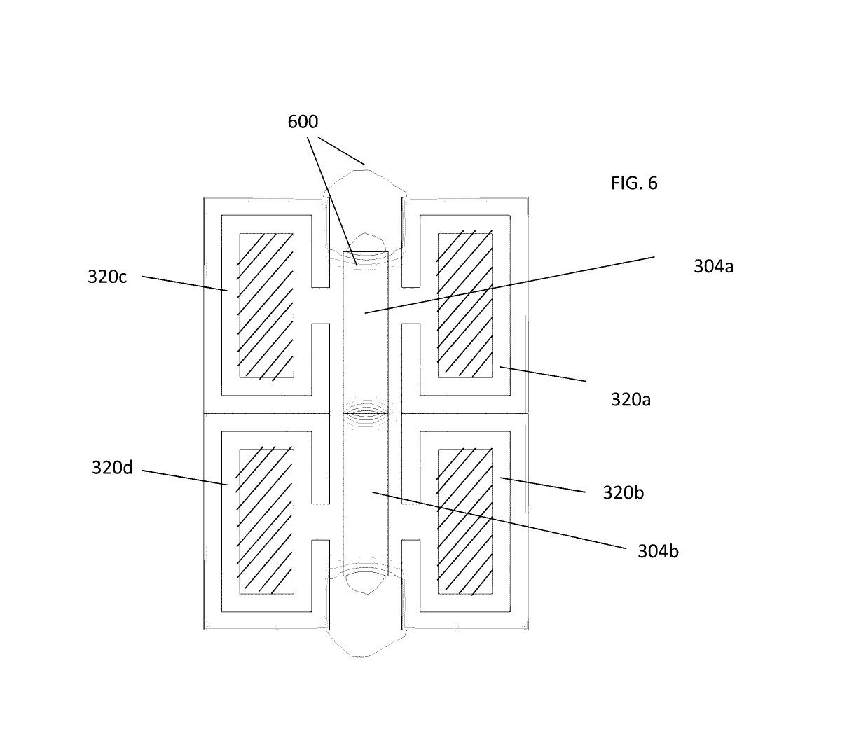

FIG. 6 shows an example of a system (taken along line 3-3) according on one embodiment and related flux lines 600 when no current is applied to the windings. This illustration includes only the PMs 304a, 304b, the cores 320 and the windings 360. In this state, only the PMs 304 are producing flux.

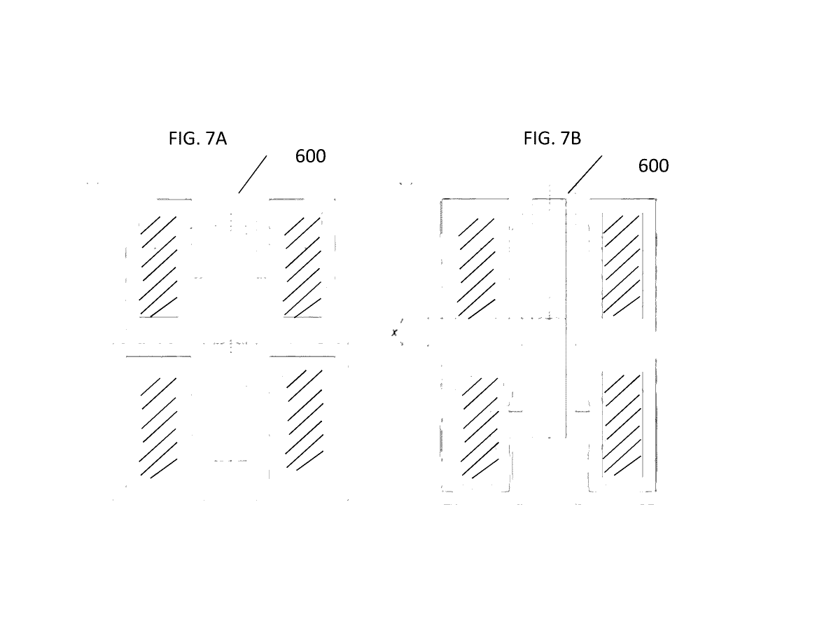

Contrasting FIG. 6 to FIGS. 7A and 7B which, respectively, shown the flux lines that exist when a DC current is applied to the windings when the PMs have displace a distance in the +x direction. In particular, in FIGS. 6, 7A and 7B, the flux lines shown are formed off of a simulation where w=36 mm, the cores are separated by 8 mm, L=30 mm, H=24 mm, h=18 mm, a=4 mm, the width of the PMs=5 mm, the magnetomotive force MMF is 5000 Aturns (ampturns), and the PMs formed of NdFeB grade 35 PMs.

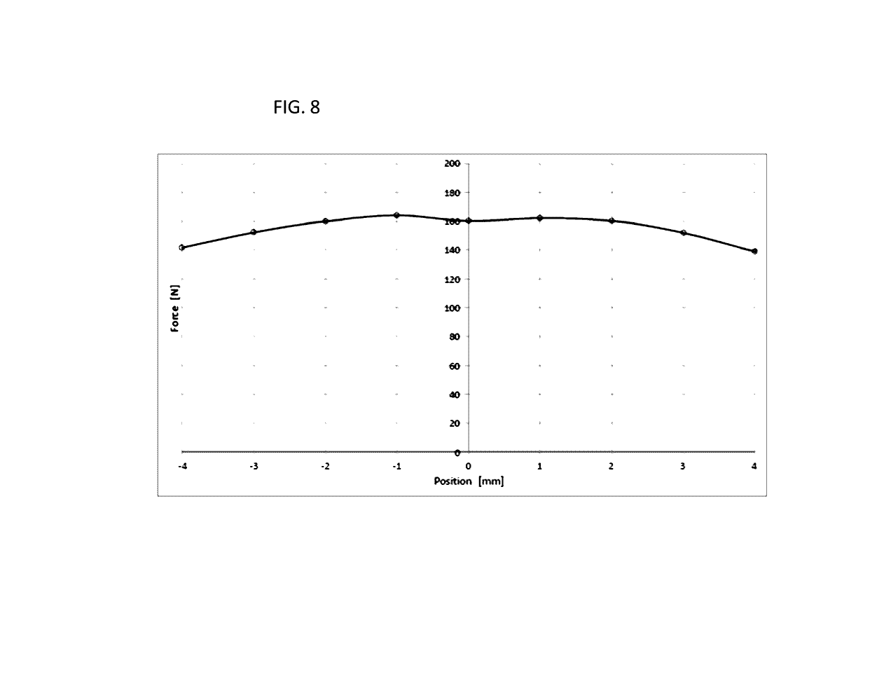

FIG. 8 shows force plotted against the position of plunger in the x direction. 4. The constant force F=160 N=16.3 kG=36 lbf is in the interval −2<x<+2 mm. At 5000 Aturns the force density is 365.26 N/kg=35.25 kG/kg=82.11 lbf/kg.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An electromagnetic actuator comprising:
an outer housing having a central axis;
a plunger contained at least partially within the outer housing and configured to move along the central axis, the plunger including an outer layer and first and second permanent magnets disposed within the outer layer and arranged such they are magnetized in opposite directions and perpendicular to the central axis;
a first core on a first side of the central axis and outside of outer layer, the first core having a first core slot;
a second core outside of outer layer on a second side, opposite the first side of the central axis, second core having a second core slot;
a first winding and second winding, the first winding passing through the first core and the second winding passing through the second core; and
wherein the first and second cores are arranged such that the first and second core slots form a gap between the first and second windings and the first and second permanent magnets;
wherein the first and second core slots have a slot opening width (a), the first and second magnets have a magnet height (h) measured along the central axis that the first and second cores have a core height (H) measured along the central axis and wherein:
h>a;
H>h; and
H−h<0.5 H.

2. The electromagnetic actuator of claim 1, wherein the first core slot provides an opening through the first core between the first winding and at least one of the first and second magnets.

3. The electromagnetic actuator of claim 1, further comprising:
a third core on the first side, the third core having a third core slot; and
a fourth core on the second side, the fourth core having a fourth core slot;
wherein the first winding passes through the third core and the second winding passes through the fourth core.

4. The electromagnetic actuator of claim 1, wherein:
the first core includes a third core slot and the second core includes a fourth core slot; and
the first winding passes surrounds a first arm in the first core between the first and third core slots and the second winding surrounds a second arm in the second core between the second and fourth core slots.

5. The electromagnetic actuator of claim 1, wherein the first and second cores are formed of sintered powder or steel.

6. The electromagnetic actuator of claim 1, wherein the first and second windings are formed of round or rectangular wire.

7. The electromagnetic actuator of claim 1, wherein the first and second windings are formed of copper foil or aluminum foil.

8. The electromagnetic actuator of claim 1, wherein the plunger further include non-ferromagnetic material on outer ends of the plunger disposed within the outer layer.

9. The electromagnetic actuator of claim 1, further comprising:
one or more linear bearings disposed between the outer layer and the outer housing.

10. A method of forming an electromagnetic actuator comprising:
forming a plunger having a central axis, the plunger including an outer layer and first and second permanent magnets disposed within the outer layer and arranged such they are magnetized in opposite directions and perpendicular to the central axis;
disposing a first core assembly on a first side of the central axis and outside of outer layer, the first core assembly including a first core having a first core slot and a first winding passing through the first core; and
disposing a second core assembly on a second, opposite side of the central axis and outside of outer layer, the second core assembly including a second core having a second core slot and a second winding passing through the second core;
wherein the first and second cores are disposed such that the first and second core slots form a gap between the first and second windings and the first and second permanent magnets;
wherein the first and second core slots have a slot opening width (a), the first and second magnets have a magnet height (h) measured along the central axis that the first and second cores have a core height (H) measured along the central axis and wherein:
h>a;
H>h; and
H−h<0.5 H.

11. The method of forming an electromagnetic actuator of claim 10, wherein the first core is arranged such that the first core slot provides an opening through the first core between the first winding and at least one of the first and second magnets.

12. The method of forming an electromagnetic actuator of claim 10, wherein:
the first core assembly includes third core, the third core having a third core slot; and
the second core assembly includes a fourth core, the fourth core having a fourth core slot; and
the first winding passes through the third core and the second winding passes through the fourth core.

13. yhe method of forming an electromagnetic actuator of claim 10, wherein:
the first core includes a third core slot and the second core includes a fourth core slot; and
the first winding passes surrounds a first arm in the first core between the first and third core slots and the second winding surrounds a second arm in the second core between the second and fourth core slots.

14. The method of forming an electromagnetic actuator of claim 10, wherein the first and second cores are formed of sintered powder or steel.

15. The method of forming an electromagnetic actuator of claim 10, wherein the first and second windings are formed of round or rectangular wire.

16. The method of forming an electromagnetic actuator of claim 10, wherein the first and second windings are formed of copper foil or aluminum foil.

17. The method of forming an electromagnetic actuator of claim 10, wherein forming the plunger includes disposing non-ferromagnetic material within the outer layer on outer ends of the plunger.
